(19) United States
(12) Patent Application Publication
(10) Pub. No.: US 2025/0038586 A1
(43) Pub. Date: Jan. 30, 2025

(54) STATOR CORE

(71) Applicant: Samsung Electronics Co., Ltd., Suwon-si (KR)

(72) Inventors: Jinwoo CHO, Suwon-si (KR); Ukho SEO, Suwon-si (KR); Jaewoong JUNG, Suwon-si (KR)

(21) Appl. No.: 18/918,820

(22) Filed: Oct. 17, 2024

Related U.S. Application Data
(63) Continuation of application No. PCT/KR2023/004529, filed on Apr. 4, 2023.

(30) Foreign Application Priority Data
Jun. 3, 2022 (KR) 10-2022-0068462

(51) Int. Cl. H02K 1/14

(52) U.S. Cl. CPC H02K 1/146

(57) ABSTRACT

A stator core formed by stacking and then bending a plurality of straight core pieces having a plurality of bending portions is provided, wherein the core pieces each include a plurality of first core pieces and a plurality of second core pieces stacked between the plurality of first core pieces, and the bending portions each include a connecting portion formed at the same position of the plurality of first core pieces and the plurality of second core pieces when the plurality of first core pieces and the plurality of second core pieces are stacked, a first bending portion formed by cutting the plurality of first core pieces and formed on one side of the connecting portion with respect to the center of the connecting portion, and a second bending portion formed by cutting the plurality of second core pieces and formed on the other side of the connecting portion with respect to the center of the connecting portion, and wherein based on the plurality of first core pieces and the plurality of second core pieces being stacked, the first bending portion is entirely covered by the second core pieces, and the second bending portion is entirely covered by the first core pieces.

### CROSS-REFERENCE TO RELATED APPLICATION(S)

This application is a continuation application, claiming priority under § 365(c), of an International application No. PCT/KR2023/004529, filed on Apr. 4, 2023, which is based on and claims the benefit of a Korean patent application number 10-2022-0068462, filed on Jun. 3, 2022, in the Korean Intellectual Property Office, the disclosure of which is incorporated by reference herein in its entirety.

### BACKGROUND

### 1. Field

The disclosure relates to a stator core having bending portions formed at different positions for bending after stacking a plurality of core pieces having a straight line shape.

### 2. Description of Related Art

In general, a motor is a device that converts electromagnetic energy into kinetic energy to produce power. A motor includes a stator and a rotor, which rotates by generating a torque on the rotor due to the electromagnetic field created when current flows through a coil wound on the stator.

Motors may be categorized according to the position of the rotor relative to the stator into an outer rotor motor, where the rotor is positioned on the outside of the stator, and an inner rotor motor, where the rotor is positioned on the inside of the stator.

Outer rotor motors have the advantage of higher power output compared to inner rotor motors of similar size. For this reason, outer rotor motors are used in a variety of product groups that require miniaturization of the motor.

The stator of an outer rotor motor may include an annular yoke having a predetermined curvature, and a stator core including a plurality of teeth protruding outwardly in a radial direction of the yoke and on which coils are wound.

To reduce the amount of electrical steel used, the stator core may be formed by blasting the electrical steels into a straight shape to produce a straight core piece, stacking a plurality of core pieces, and then bending the core pieces.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a stator core in which a plurality of core pieces having a straight line are stacked and then bending sections for bending are formed at different positions when the plurality of core pieces are laminated.

Additional aspects will be set forth in part in the description which follows and, in part, will be apparent from the description, or may be learned by practice of the presented embodiments.

In accordance with an aspect of the disclosure, a stator core formed by stacking and then bending a plurality of straight core pieces having a plurality of bending portions is provided. The core pieces each include a plurality of first core pieces and a plurality of second core pieces stacked between the plurality of first core pieces, and the bending portions each include a connecting portion formed at the same position of the plurality of first core pieces and the plurality of second core pieces when the plurality of first core pieces and the plurality of second core pieces are stacked, a first bending portion formed by cutting the plurality of first core pieces and formed on one side of the connecting portion with respect to the center of the connecting portion, and a second bending portion formed by cutting the plurality of second core pieces and formed on the other side of the connecting portion with respect to the center of the connecting portion, and wherein based on the plurality of first core pieces and the plurality of second core pieces being stacked, the first bending portion is entirely covered by the second core pieces, and the second bending portion is entirely covered by the first core pieces.

The first bending portion and the second bending portion may be formed to have shapes that are symmetrical with respect to the connecting portion.

The first bending portion and the second bending portion may be formed at positions that are symmetrical with respect to the connecting portion.

The core pieces may be formed by bending a plurality of core pieces into an arc shape, and the plurality of core pieces bent into the arc shape are assembled into an annular shape.

The core pieces may include an arc-shaped yoke, and a plurality of teeth protruding radially from the yoke and on which a coil is wound.

The bending portion may be formed in the plurality on the yoke so as to be positioned between the plurality of teeth.

The connecting portion may connect the yoke cut by the first bending portion and the second bending portion.

The connecting portion may include a first bending groove formed to be radially recessed inwardly on an outer circumferential surface of the yoke, and a second bending groove formed on a lower portion of the first bending groove so as to be connected to the first bending portion and the second bending portion.

The core pieces may be stacked with the plurality of first core pieces and the plurality of second core pieces alternating one by one.

The core pieces may be stacked with the plurality of first core pieces and the plurality of second core pieces alternating in multiples.

The core pieces may include an overlapping portion that overlaps between the first bending portion and the second bending portion when the plurality of first core pieces and the plurality of second core pieces are stacked.

The overlapping portion may be formed on a side of the plurality of first core pieces facing the connecting portion of the first bending portion with respect to the center of the connecting portion, and is formed on a side of the plurality of second core pieces facing the connecting portion of the second bending portion with respect to the center of the connecting portion.

The overlapping portion may be formed to have a larger area when the core pieces are bent than when the core pieces are in a straight shape.

The core pieces may include an assembly protrusion formed at one end of the yoke and an assembly groove formed at the other end of the yoke into which the assembly protrusion is assembled when the plurality of core pieces are formed into the annular shape.

According to various embodiments of the disclosure, the magnetic resistance in the gap between the bending portions can be reduced after bending of the core pieces, thereby improving the performance of the motor.

Further, according to various embodiments of the disclosure, the rigidity of the stator core can be increased, thereby improving the noise and vibration of the motor.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a motor according to an embodiment of the disclosure;

FIG. 2 is an exploded view illustrating a rotor according to an embodiment of the disclosure;

FIG. 3 is an exploded view illustrating a stator according to an embodiment of the disclosure;

FIG. 4 is an exploded view of a straight first core piece and a second core piece according to an embodiment of the disclosure;

FIG. 5 is a view illustrating a plurality of straight core pieces stacked according to an embodiment of the disclosure;

FIG. 6 is a view illustrating an overlapping portion formed when a first and second core pieces of a straight core pieces are stacked according to an embodiment of the disclosure;

FIG. 7 is a cross-sectional view schematically illustrating a bending portion when a plurality of straight core pieces are stacked according to an embodiment of the disclosure;

FIG. 8 is a view of a plurality of stacked core pieces when bent according to an embodiment of the disclosure;

FIG. 9 is a view illustrating an overlapping portion widened by bending a stacked first and second core pieces according to an embodiment of the disclosure;

FIG. 10 is a detailed view of a bending portion when a stacked first and second core pieces are bent according to an embodiment of the disclosure;

FIG. 11 is a schematic view illustrating a bending portion when a plurality of stacked core pieces are bent according to an embodiment of the disclosure;

FIG. 12 is a view illustrating a plurality of first core pieces and a plurality of second core pieces alternately stacked in two by two according to an embodiment of the disclosure;

FIG. 13 is a view illustrating a plurality of first core pieces and a plurality of second core pieces alternately stacked in three by three according to an embodiment of the disclosure;

FIG. 14 is a view illustrating two of a plurality of stacked core pieces bent and assembled according to an embodiment of the disclosure; and

FIG. 15 is a view illustrating one plurality of stacked core pieces bent and assembled according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an” and “the” include the plural referents unless the context clearly dictates otherwise. Thus, for example, reference to “a component surface” includes reference to one or more of such surfaces.

In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, or the like, may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

As used herein, the terms “front”, “rear”, “upper”, “lower”, “left”, “right”, and the like are defined with reference to the drawings and are not intended to limit the shape and location of each component.

Hereinafter, various embodiments according to the disclosure will be described with reference to the accompanying drawings.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

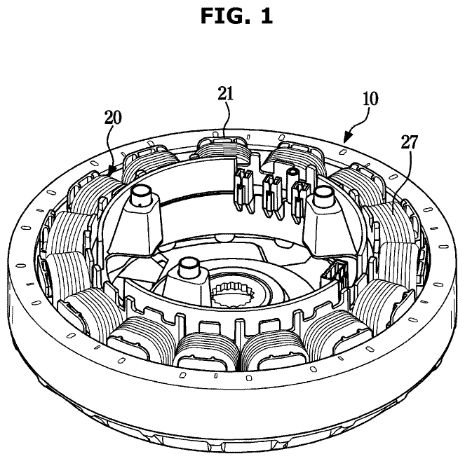

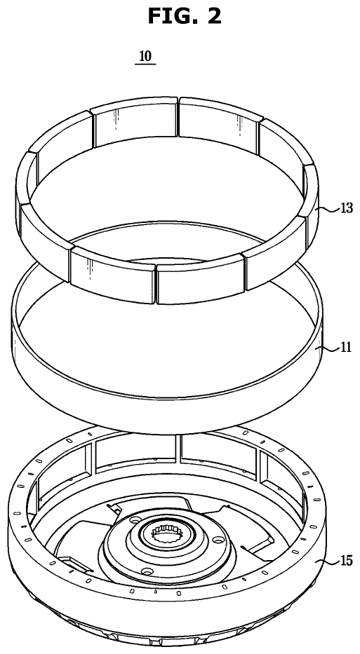

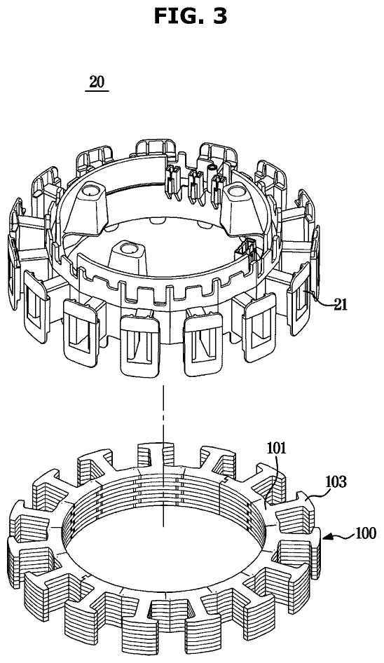

FIG. 1 is a view illustrating a motor according to an embodiment of the disclosure. FIG. 2 is an exploded view illustrating a rotor according to an embodiment of the disclosure. FIG. 3 is an exploded view illustrating a stator according to an embodiment of the disclosure.

Referring to FIGS. 1 to 3, a motor may include a rotor 10 and a stator 20. The rotor 10 may be configured to rotate relative to the stator 20. The rotor 10 may be configured to rotate by electromagnetically interacting with the stator 20.

The motor may be an outer rotor motor in which the rotor 10 is disposed on an outside of the stator 20. An outer rotor motor may have the advantage of having a large power output relative to the size of the motor compared to an inner rotor motor in which the rotor is disposed on an inside of the stator. Accordingly, an outer rotor motor may produce high power in a relatively small size, which is advantageous for miniaturization. Although the drawings show a case in which the motor is an outer rotor motor, the disclosure is not limited thereto. For example, the motor may be an inner rotor motor.

Although not shown in the drawings, the motor of the disclosure may be used in a variety of products. For example, the motor may be used in a compressor of a washing machine and a refrigerator, a compressor of an air conditioner, a compressor of a water purifier that provides cold water, and the like, and the application is not limited thereto.

The rotor 10 may include a yoke 11, a magnet 13 disposed within the yoke 11, and a frame 15 in which a shaft (not shown) is inserted and supported.

The yoke 11 may be formed of an annular sheet of iron and may be arranged to surround a stator core 100.

The magnet 13 may be disposed within the yoke 11. The magnet 13 may be disposed such that its outer surface abuts an inner surface of the yoke 11. The magnet 13 may be provided in a plurality. The plurality of magnets 13 may be arranged to be spaced apart along a circumferential direction of the yoke 11.

The frame 15 may be provided to accommodate the yoke 11 and the magnets 13. A shaft (not shown) may be inserted into and supported by the frame 15. The frame 15 may be formed by injection molding. The rotor 10 may be provided by placing the yoke 11 and the magnets 13 in a mold and then injecting the frame 15. In other words, because the rotor 10 is formed by inserting the yoke 11 and the magnets 13 into the injection mold and then injecting resin to form the frame 15, the rotor 10 may be formed integrally without separate fastening or adhesive members.

Unlike the yoke 11 and the magnets 13 which are made of metal, the frame 15 may be formed of a plastic material that may be injected. Since the frame 15 is made of a plastic material, the weight of the rotor 10 and the motor including the rotor 10 may be reduced.

The stator 20 may include the stator core 100 and an insulator 21 surrounding the stator core 100.

The stator core 100 may include a ring-shaped yoke 101 and a plurality of teeth 103 protruding radially outward from the yoke 101 and on which a coil 27 is wound. Although the plurality of teeth 103 are shown in the drawings as protruding radially outward from the yoke 101, the disclosure is not limited thereto. For example, based on the motor being an inner rotor motor, the plurality of teeth may protrude radially inward from the yoke. The stator core 100 may be formed by stacking a plurality of core pieces 110 in the shape of a straight line and then bending them, as will be described below.

The insulator 21 may be formed by injection molding the stator core 100 so as to surround the stator core 100. In other words, the insulator 21 may be formed integrally so as to surround the stator core 100. However, the disclosure is not limited thereto, and the insulator 21 may include a first insulator and a second insulator that are coupled to an upper and lower portions of the stator core 100 and surround the upper and lower portions of the stator core 100, respectively. In other words, the first insulator and the second insulator 25 may be respectively formed and coupled to each other to cover the upper and lower portions of the stator core 100.

The insulator 21 may include the coil 27 wound around the plurality of teeth 103 of the stator core 100. The insulator 21 may be formed from an electrically insulating material. For example, the insulator 21 may be an injection molded product. The coil 27 may be wound around the insulator 21 covering the plurality of teeth 103. The insulator 21 may prevent the coil 27 from directly contacting the stator core 100 by covering the plurality of teeth 103.

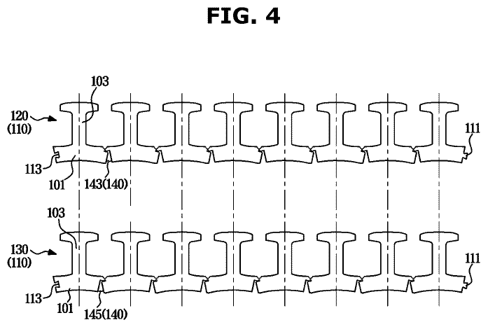

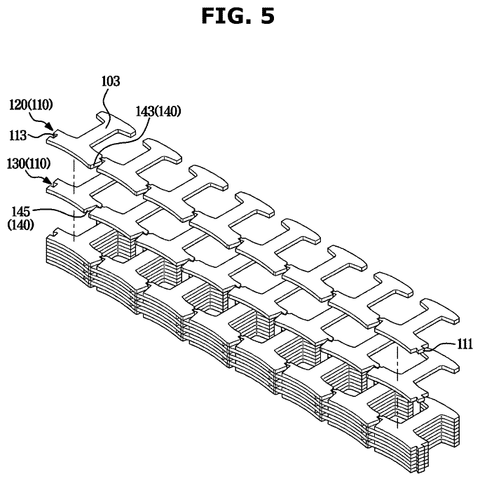

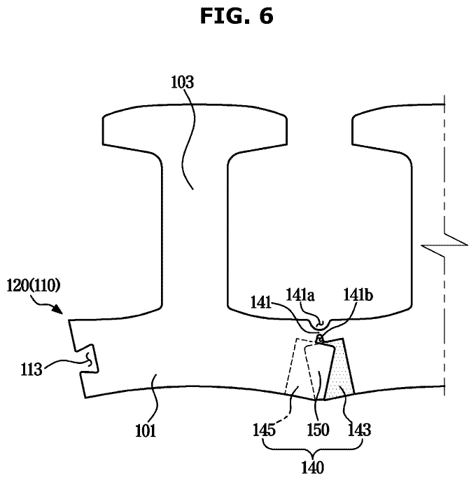

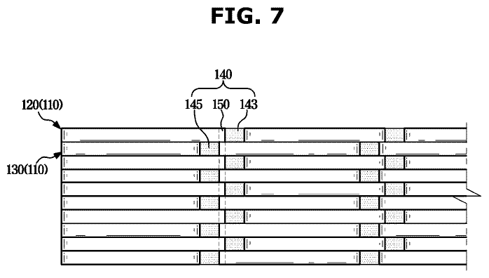

FIG. 4 is an exploded view of a straight first core piece and a straight second core piece according to an embodiment of the disclosure. FIG. 5 is a view illustrating a plurality of straight core pieces stacked according to an embodiment of the disclosure. FIG. 6 is a view illustrating an overlapping portion formed when a first and second core pieces of a straight core pieces are stacked according to an embodiment of the disclosure. FIG. 7 is a cross-sectional view schematically illustrating a bending portion when a plurality of straight core pieces are stacked according to an embodiment of the disclosure.

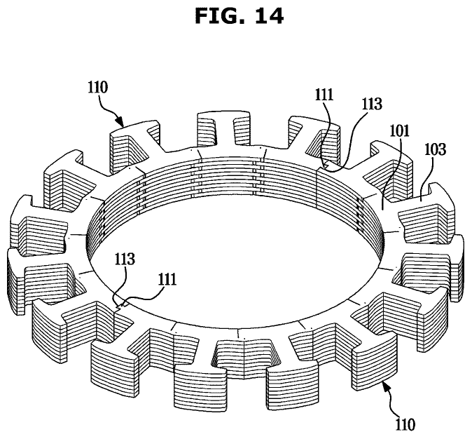

Referring to FIGS. 4, 5, 6, and 7, the stator core 100 may include the plurality of core pieces 110 formed in a straight line. The stator core 110 may be manufactured into a ring shape by stacking the plurality of straight core pieces 110 and then bending them. Each of the plurality of core pieces 110 may include a plurality of bending portions 140 to facilitate bending (see FIG. 14).

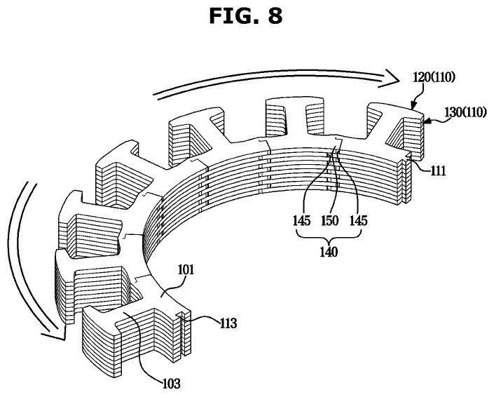

Each core piece 110 may be manufactured by pressing electrical steel sheets to a given thickness by a pressing process and then blasting. Each of the core pieces 110 may include the yoke 101 and the plurality of teeth 103. When the core piece 110 is bent, the yoke 101 may be formed into an arc shape. The plurality of teeth 103 may protrude from an outer circumferential surface of the yoke 101. The outer circumferential surface of the yoke 101 may be the outer circumferential surface when the core piece 110 is bent into an arc shape. When the core piece 110 is bent, the plurality of teeth 103 may protrude radially outward from the outer circumferential surface of the yoke 101. The plurality of bending portions 140 may be formed on the yoke 101 so as to be positioned between the plurality of teeth 103 (see FIGS. 8 to 10).

The core piece 110 may include a plurality of first core pieces 120 and a plurality of second core pieces 130. The plurality of first core pieces 120 and the plurality of second core pieces 130 may be alternately stacked one on top of the other. Each of the plurality of first core pieces 120 may include a first bending portion 143. A second bending portion 145 may be formed on each of the plurality of second core pieces 130. The first bending portion 143 and the second bending portion 145 may be positioned such that they do not overlap each other when the plurality of first core pieces 120 and the plurality of second core pieces 130 are stacked.

The core piece 110 may include an assembly protrusion 111 formed at one end of the yoke 101. The core piece 110 may include an assembly groove 113 formed at the other end of the yoke 101. When the plurality of core pieces 110 are stacked and then bent to form a ring shape, the assembly protrusion 111 may be assembled to the assembly groove 113 (see FIG. 14).

The bending portion 140 may include a connecting portion 141 formed at the same position of the plurality of first core pieces 120 and the plurality of second core pieces 130 when the plurality of first core pieces 120 and the plurality of second core pieces 130 are stacked. The connecting portion 141 may connect the yoke 101 that is cut by the first bending portion 143 and the second bending portion 145.

The connecting portion 141 may include a first bending groove 141a formed to be radially recessed inwardly on the outer circumferential surface of the yoke 101. The connecting portion 141 may include a second bending groove 141b formed at a lower portion of the first bending groove 141a to connect the first bending portion 143 and the second bending portion 145. With the first bending groove 141a and the second bending groove 141b formed at the connecting portion 141, the plurality of first core pieces 120 and the plurality of second core pieces 130 stacked together may be more easily bent. However, it is not necessary for the first bending groove 141a and the second bending groove 141b to be formed at the connecting portion 141. In other words, only one of the first bending groove 141a and the second bending groove 141b may be formed at the connecting portion 141. Alternatively, both the first bending groove 141a and the second bending groove 141b may not be formed at the connecting portion 141.

The bending portion 140 may include the first bending portion 143 formed on the plurality of first core pieces 120 and the second bending portion 145 formed on the plurality of second core pieces 130.

The first bending portion 143 may be formed by cutting the plurality of first core pieces 120. The second bending portion 145 may be formed by cutting the plurality of second core pieces 130. The first bending portion 143 and the second bending portion 145 may be formed at different positions when the first core pieces 120 and the second core pieces 130 are stacked. In other words, the first bending portion 143 and the second bending portion 145 may be located at positions where they do not overlap each other when the plurality of first core pieces 120 and the plurality of second core pieces 130 are stacked.

The first bending portion 143 and the second bending portion 145 may be formed on one side and the other side of the connecting portion 141, respectively, based on the center of the connecting portion 141. While the drawings illustrate that the first bending portion 143 being formed on the right side of the connecting portion 141 and the second bending portion 145 being formed on the left side of the connecting portion 141, but the disclosure is not limited thereto. In other words, the first bending portion 143 may be formed on the left side of the connecting portion 141 and the second bending portion 145 may be formed on the right side of the connecting portion 141.

When the plurality of first core pieces 120 and the plurality of second core pieces 130 are stacked, the entire first bending portion 143 formed on the first core piece 120 may be covered by the second core piece 130. In other words, when the second core piece 130 is stacked on top of the first core piece 120, the first bending portion 143 formed on the first core piece 120 may be entirely covered by the second core piece 130. When the plurality of first core pieces 120 and the plurality of second core pieces 130 are stacked, the entire second bending portion 145 formed on the second core piece 130 may be covered by the first core piece 120. In other words, when the first core piece 120 is stacked on top of the second core piece 130, the second bending portion 145 formed on the second core piece 130 may be entirely covered by the first core piece 120.

The first bending portion 143 and the second bending portion 145 may be formed to have a shape that is symmetrical to each other with respect to the connecting portion 141. The first bending portion 143 and the second bending portion 145 may be formed at a position that is symmetrical to each other with respect to the connecting portion 141. However, the shapes and positions of the first bending portion 143 and the second bending portion 145 need not to be completely symmetrical, and it may be sufficient if, when the plurality of first core pieces 120 and the plurality of second core pieces 130 are stacked, the first bending portion 143 and the second bending portion 145 do not overlap and the entire first bending portion 143 and the entire second bending portion 145 are covered by the second core piece 130 and the first core piece 120, respectively.

The core piece 110 may include an overlapping portion 150 that overlaps between the first bending portion 143 and the second bending portion 145 when the plurality of first core pieces 120 and the plurality of second core pieces 130 are stacked. The overlapping portion 150 may be formed on a side of the plurality of first core pieces 120 facing the connecting portion 141 of the first bending portion 143 with respect to the center of the connecting portion 141 in the plurality of first core pieces 120. In other words, the overlapping portion 150 may be formed on the left side of the first bending portion 143 of the first core piece 120. However, this is only an example shown in the drawings, and the position of the overlapping portion 150 may vary depending on the position of the first bending portion 143. In other words, in response to the first bending portion 143 being formed on the left side of the connecting portion 141, the overlapping portion 150 may be formed on the right side of the first bending portion 143 in the first core piece 120.

The overlapping portion 150 may be formed on a side of the plurality of second core pieces 130 facing the connecting portion 141 of the second bending portion 145 with respect to the center of the connecting portion 141 in the plurality of second core pieces 130. In other words, the overlapping portion 150 may be formed on the right side of the second bending portion 145 in the second core piece 130. However, this is only an example shown in the drawings, and the position of the overlapping portion 150 may vary depending on the position of the second bending portion 145. In other words, in response to the second bending portion 145 being formed on the right side of the connecting portion 141, the overlapping portion 150 may be formed on the left side of the second bending portion 145 in the second core piece 130.

Based on the plurality of first core pieces 120 and the plurality of second core pieces 130 are stacked, when the core piece 110 is bent in a state in which the first bending portion 143 and the second bending portion 145 do not overlap each other and the overlapping portion 150 exists between the first bending portion 143 and the second bending portion 145, the core piece 110 may be bent easily. The bending portion 140 of the core piece 110, which is manufactured by a blanking process after the electrical steel sheet is made to a given thickness by a pressing process, may have burrs. Burrs generated at the bending portion 140 of the core piece 110 may cause a problem that the core piece 110 is not bent when the plurality of core pieces 110 are stacked. However, based on the plurality of first core pieces 120 and the plurality of second core pieces 130 being stacked, when the core piece 11o is bent in a state in which the first bending portion 143 and the second bending portion 145 do not overlap each other and the overlapping portion 150 exists between the first bending portion 143 and the second bending portion 145, the core piece 110 may be bent easily. This is because that the plurality of first core pieces 120 and the plurality of second core pieces 130 may not be bent when the plurality of first core pieces 120 and the plurality of second core pieces 130 are stacked due to burrs generated at the first bending portion 143 and the second bending portion 145.

When the plurality of first core pieces 120 and the plurality of second core pieces 130 are stacked in a state in which the overlapping portion 150 is positioned between the first bending portion 143 and the second bending portion 145 and then the core piece 110 is bent, the problem of the core piece 110 not being bent due to burrs when the plurality of first core pieces 120 and the plurality of second core pieces 130 are stacked may be addressed.

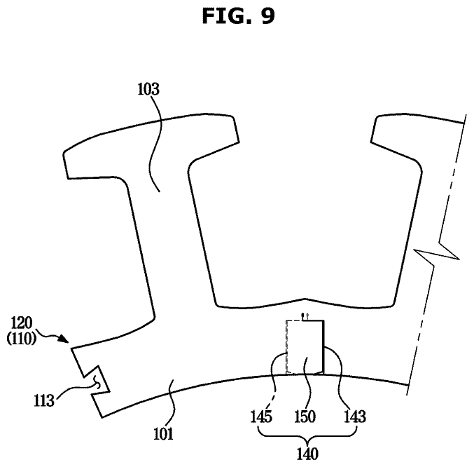

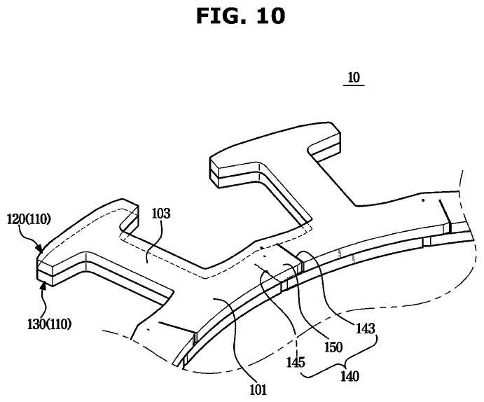

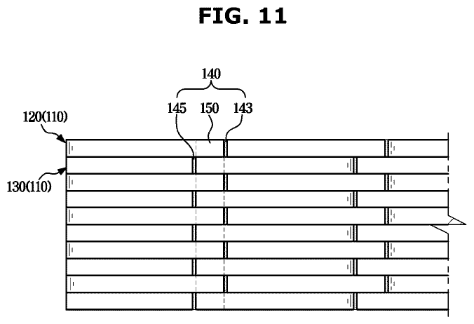

FIG. 8 is a view of a plurality of stacked core pieces according to an embodiment of the disclosure. FIG. 9 is a view of an overlapping portion widened by bending a stacked first and second core pieces according to an embodiment of the disclosure. FIG. 10 is a detailed view of a bending portion when a stacked first core pieces and second core pieces are bent according to an embodiment of the disclosure. FIG. 11 is a schematic view illustrating a bending portion when a plurality of stacked core pieces are bent according to an embodiment of the disclosure.

Referring to FIGS. 8, 9, 10, and 11, the plurality of first core pieces 120 and the plurality of second core pieces 130 stacked together may be bent into an arc shape. When the plurality of first core pieces 120 and the plurality of second core pieces 130 stacked together are bent, the yoke 101 may be formed into an arc shape. The plurality of teeth 103 may protrude radially outward from the outer circumferential surface of the yoke 101. The bending portions 140 may be formed on the yoke 101 in a plurality so as to be positioned between the plurality of teeth 103.

When the plurality of first core pieces 120 and the plurality of second core pieces 130 stacked together are bent, the first bending portion 143 and the second bending portion 145, which are cut and separated at both ends, may be brought into contact at both ends so that no gap occurs. When the two cut ends are brought into contact with each other and no gap occurs, the magnetic flux generated in the core piece 110 may flow well. In other words, the magnetic resistance in the gap between the two cut ends may be reduced to increase the magnetic flux density, thereby improving the performance of the motor.

However, when the plurality of first core pieces 120 and the plurality of second core pieces 130 that are stacked are bent, the first bending portion 143 and the second bending portion 145 that are cut and separated at both ends may have difficulty in completely contacting each other so that the gap is not generated. In other words, there may be some areas at both ends that are not in contact and a gap is formed.

In the disclosure, when the plurality of first core pieces 120 and the plurality of second core pieces 130 are formed in a straight line and stacked together, the overlapping portion 150 may be formed, wherein the overlapping portion 150 may be formed to have a larger area when the core piece 110 is bent. In other words, the overlapping portion 150 may be formed as a portion of the area between the first bending portion 143 and the second bending portion 145 when the plurality of first core pieces 120 and the plurality of second core pieces 130 are formed in a straight line and stacked together, but the area of the overlapping portion 150 may be larger when the plurality of first core pieces 120 and the plurality of second core pieces 130 stacked together are bent. Accordingly, when the plurality of first core pieces 120 and the plurality of second core pieces 130 stacked are bent, even if the first bending portion 143 and the second bending portion 145, which were cut and spaced apart at both ends, are not completely in contact at both ends and thus a gap is formed, the magnetic resistance may be reduced by the overlapping portion 150, thereby increasing the magnetic flux density, which may improve the performance of the motor. In addition, since the yoke 101, which is connected only by the connecting portion 141, is also connected by the overlapping portion 150, the rigidity of the stator core 100 may be increased. When the rigidity of the stator core 100 is increased, the natural frequency may be increased, which may improve the noise and vibration of the motor.

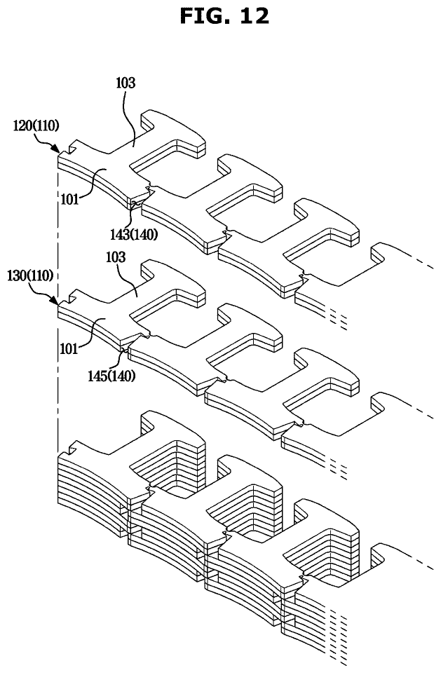

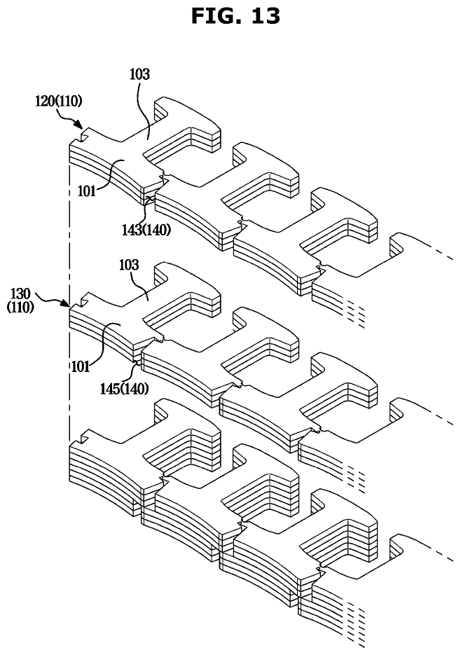

FIG. 12 is a view illustrating a plurality of first core pieces and a plurality of second core pieces alternately stacked in two by two according to an embodiment of the disclosure. FIG. 13 is a view illustrating a plurality of first core pieces and a plurality of second core pieces alternately stacked in threes by three according to an embodiment of the disclosure.

Referring to FIGS. 12 and 13, the plurality of first core pieces 120 and the plurality of second core pieces 130 may be alternately stacked in pairs or in threes. The plurality of first core pieces 120 and the plurality of second core pieces 130 may be alternately stacked in four or more. However, the disclosure may be preferred that the plurality of first core pieces 120 and the plurality of second core pieces 130 are alternately stacked one by one.

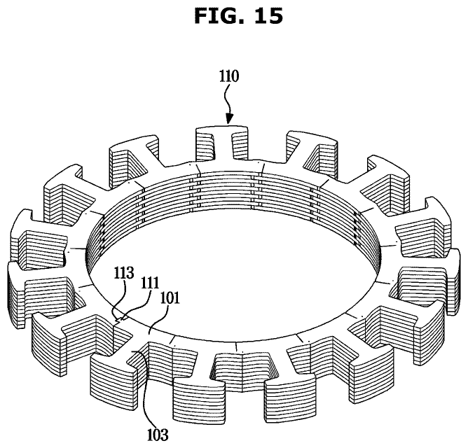

FIG. 14 is a view illustrating two of a plurality of stacked core pieces bent and assembled according to an embodiment of the disclosure. FIG. 15 is a view illustrating one plurality of stacked core pieces bent and assembled according to an embodiment of the disclosure.

Referring to FIG. 14, the plurality of stacked core pieces 110 may be bent so that two of the plurality of stacked core pieces each have an arc shape, and then the assembly protrusion 111 may be assembled into the assembly groove 113 to form the annular stator core 100. However, the disclosure is not limited thereto, and the plurality of stacked core pieces 110 may be bent so that three or more of the plurality of stacked core pieces each have an arc shape, and then the assembly protrusion 111 may be assembled into the assembly grooves 113 to form the annular stator core 100.

Referring to FIG. 15, the plurality of stacked core pieces 110 may form an annular stator core 100 by allowing one in which the plurality of stacked core pieces are provided as a single to be bent into an annular shape, and then assembling the assembly protrusion 111 into the assembly groove 113.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those of skilled in the art that various changes in form and details may be made therein without departing from the spirit and scope of the disclosure as defined by the appended claims and their equivalents.

What is claimed is:

1. A stator core formed by stacking and then bending a plurality of straight core pieces having a plurality of bending portions,
wherein the core pieces each comprise:
a plurality of first core pieces, and
a plurality of second core pieces stacked between the plurality of first core pieces,
wherein the bending portions each comprise:
a connecting portion formed at the same position of the plurality of first core pieces and the plurality of second core pieces when the plurality of first core pieces and the plurality of second core pieces are stacked,
a first bending portion formed by cutting the plurality of first core pieces and formed on one side of the connecting portion with respect to the center of the connecting portion, and
a second bending portion formed by cutting the plurality of second core pieces and formed on the other side of the connecting portion with respect to the center of the connecting portion, and
wherein based on the plurality of first core pieces and the plurality of second core pieces being stacked, the first bending portion is entirely covered by the second core pieces, and the second bending portion is entirely covered by the first core pieces.

2. The stator core of claim 1, wherein the first bending portion and the second bending portion are formed to have shapes that are symmetrical with respect to the connecting portion.

3. The stator core of claim 1, wherein the first bending portion and the second bending portion are formed at positions that are symmetrical with respect to the connecting portion.

4. The stator core of claim 1,
wherein the core pieces are formed by bending a plurality of core pieces into an arc shape, and
wherein the plurality of core pieces bent into the arc shape are assembled into an annular shape.

5. The stator core of claim 4, wherein the core pieces include an arc-shaped yoke, and a plurality of teeth protruding radially from the yoke and on which a coil is wound.

6. The stator core of claim 5, wherein the bending portion is formed in the plurality on the yoke so as to be positioned between the plurality of teeth.

7. The stator core of claim 6, wherein the connecting portion connects the yoke cut by the first bending portion and the second bending portion.

8. The stator core of claim 7, wherein the connecting portion includes a first bending groove formed to be radially recessed inwardly on an outer circumferential surface of the yoke, and a second bending groove formed on a lower portion of the first bending groove so as to be connected to the first bending portion and the second bending portion.

9. The stator core of claim 1, wherein the core pieces are stacked with the plurality of first core pieces and the plurality of second core pieces alternating one by one.

10. The stator core of claim 1, wherein the core pieces are stacked with the plurality of first core pieces and the plurality of second core pieces alternating in multiples.

11. The stator core of claim 1, wherein the core pieces include an overlapping portion that overlaps between the first bending portion and the second bending portion when the plurality of first core pieces and the plurality of second core pieces are stacked.

12. The stator core of claim 11,
wherein the overlapping portion is formed on a side of the plurality of first core pieces facing the connecting portion of the first bending portion with respect to the center of the connecting portion, and
wherein the overlapping portion is formed on a side of the plurality of second core pieces facing the connecting portion of the second bending portion with respect to the center of the connecting portion.

13. The stator core of claim 12, wherein the overlapping portion is formed to have a larger area when the core pieces are bent than when the core pieces are in a straight shape.

14. The stator core of claim 5, wherein the core pieces include an assembly protrusion formed at one end of the yoke and an assembly groove formed at the other end of the yoke into which the assembly protrusion is assembled when the plurality of core pieces are formed into the annular shape.
